(19) United States
(12) Patent Application Publication
(10) Pub. No.: US 2024/0202848 A1
(43) Pub. Date: Jun. 20, 2024

(54) INTELLECTUAL PROPERTY RIGHT MANAGEMENT SERVER, MANAGEMENT METHOD, AND PROGRAM

(71) Applicant: Final Aim Inc., Tokyo (JP)

(72) Inventors: Masafumi ASAKURA, Tokyo (JP); Yasuhide YOKOI, Tokyo (JP)

(21) Appl. No.: 17/908,903

(22) PCT Filed: Mar. 2, 2021
(86) PCT No.: PCT/JP2021/007812

§ 371 Date: Sep. 1, 2022

(30) Foreign Application Priority Data
Mar. 2, 2020 (JP) 2020-034812

(51) Int. Cl. G06Q 50/18

(52) U.S. Cl. CPC G06Q 50/184

(57) ABSTRACT

The present invention is to manage that right processing for an intellectual property is correctly performed.

The management server for the intellectual property right includes a risk determination part that determines a risk regarding the right processing of the intellectual property right according to whether or not the right processing for the intellectual property right has been performed. The management server for the intellectual property right also includes a risk output part that outputs information regarding a risk.

### TECHNICAL FIELD

The present invention relates to an intellectual property right management server, a management method, and a program.

### BACKGROUND ART

The management for the contract of the intellectual property traded between a licensor and a licensee is performed (refer to Patent Literature 1).

### CITATION LIST

### Patent Literature

Patent Literature 1: WO 2018/116451 A

### Summary of Invention

### Technical Problem

However, there is a problem when the intellectual property right to be licensed or the intellectual property right to be transferred does not correctly belong to a licensor, or a licensor is not authorized to license the intellectual property right.

The present invention has been made in view of such a background, and an object thereof is to provide a technology capable of managing that right processing for an intellectual property is correctly performed.

### Solution to Problem

A main aspect of the present invention for solving the above-described problem is an intellectual property management system including: a right processing determination part configured to acquire right processing information indicating whether or not right processing for an intellectual property right relating to a product or a service has been performed; and a risk output part configured to output information regarding a risk for an exercise of the intellectual property right in accordance with the right processing information.

Other problems disclosed in the present application and a method for solving the problems will be clarified by the sections of the embodiments of the invention and the drawings.

### Advantageous Effects of Invention

According to the present invention, it is possible to manage that the right processing for the intellectual property is correctly performed.

### BRIEF DESCRIPTION OF DRAWINGS

FIG. 1 is a diagram for explaining an intellectual property relating to business.

FIG. 2 is a diagram illustrating an overall configuration example of an intellectual property management system according to the present embodiment.

FIG. 3 is a diagram illustrating a hardware configuration example of a computer that realizes a management server 30.

FIG. 4 is a diagram illustrating a software configuration example of the management server 30.

FIG. 5 is a diagram illustrating a flow of processing of evaluating a situation of right processing.

FIG. 6 is a diagram illustrating an example of processing of evaluating a risk where a product is not protected by a design right.

FIG. 7 is a diagram illustrating an example of processing of evaluating a risk where a product is not protected by a design right in a case where product information, design information, intellectual property information, and written information are not associated with each other.

### DESCRIPTION OF EMBODIMENTS

### Summary of Invention

The details of the embodiments of the present invention will be listed and described. The present invention has, for example, the following configuration.

### [Item 1]

A management server for an intellectual property right, including:
a risk determination part configured to determine a risk regarding right processing for the intellectual property right according to whether or not the right processing for the intellectual property right has been performed; and
a risk output part configured to output information regarding the risk.

### [Item 2]

The management server for the intellectual property right according to item 1,
in which the right processing is that the intellectual property right has been transferred from a creator of the intellectual property right to a current holder of the intellectual property right,
the management server further including a written information input part configured to receive an input of written information proving transfer of the intellectual property right.

### [Item 3]

The management server for the intellectual property right according to item 2, further including
a right processing execution part configured to, in a case where the written information proving transfer of the right does not exist, create a document proving transfer of the right.

### [Item 4]

The management server for the intellectual property right according to item 1, further including
a transfer information storage part configured to store information regarding transfer of the intellectual property right.

### [Item 5]

The management server for the intellectual property right according to item 1, further including
a certificate issuing part configured to issue a certificate indicating that the right processing has been performed in a case where it is determined that the right processing for the intellectual property right has been performed.

### [Item 6]

The management server for the intellectual property right according to item 5,
in which the certificate issuing part registers the certificate in a distributed ledger of a blockchain network.

### [Item 7]

The management server for the intellectual property right according to item 1,
in which the intellectual property right is a design right, and
the risk determination part determines a state of protection of the product by the design right according to a similarity between a design for the product and a design for the design right.

### [Item 8]

A program for causing a management server for an intellectual property right to function as:
a risk determination means configured to determine a risk regarding right processing of the intellectual property right according to whether or not the right processing for the intellectual property right has been performed; and
a risk output means configured to output information regarding the risk.

### [Item 9]

A management method for an intellectual property right, including:
a risk determination step of determining a risk regarding right processing of the intellectual property right according to whether or not the right processing for the intellectual property right has been performed; and
a risk output step of outputting information regarding the risk.

### <System Overview>

An intellectual property management system according to an embodiment of the present invention will be described below. The intellectual property management system according to the present embodiment is to support appropriate execution of right processing for an intellectual property relating to a product or a service (hereinafter, a service is also referred to as a product).

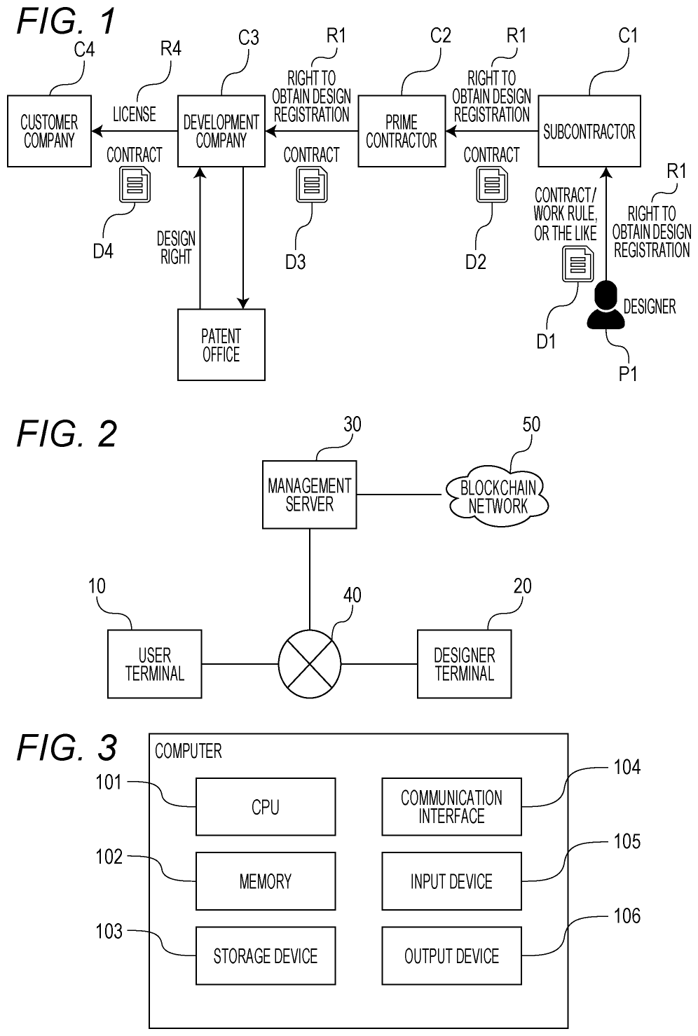

For example, FIG. 1 is a diagram for describing an intellectual property relating to business. In an example of FIG. 1, a situation is assumed in which a development company C3 that performs planning and development of a product grants a license R4 relating to production and sales of a product to a customer company C4 that performs production and sales of the product. A right for the license R4 may be various types of intellectual property rights such as a patent right, a trademark right, and a copyright; however, a design right relating to a design of a product will be described as an example. Note that, in the present embodiment, it is assumed that the intellectual property right (for example, design right) includes the right to acquire the intellectual property right (for example, the right to obtain a design registration). In addition, the same applies to a case where the right is sold (transferred) instead of granting the license R4. It is assumed that in the intellectual property management system of the present embodiment, right processing for the design right subject to the license R4 is appropriately performed. In the present embodiment, the right processing means that the development company C3 appropriately and reliably acquires the intellectual property right licensed or transferred from the development company C3 to the customer company C4. In order to determine whether the right to obtain a design registration has been transferred from the creator P1 to the development company C3, the intellectual property management system according to the present embodiment can confirm that there is a document (evidence) proving the transfer. In a case where it can be confirmed that the development company C3 has received the license with the sublicense from the prime contractor C2, the development company C has the authority to grant the license to the customer company C4. Therefore, in relation to the purpose of granting the license to the customer company C4, it is not essential that the right to obtain a design registration belongs to C3.

The example of FIG. 1 illustrates that the development company C3 requests a design to the prime contractor C2 in product development. It is considered that the prime contractor C2 delivers the design to the development company C3 together with the right to obtain a design registration R1. In that case, since there is a contract to transfer the right to obtain a design registration R1 from the prime contractor C2 to the development company C3, there should be a contract D3 indicating the contract. The intellectual property management system according to the present embodiment manages whether or not this contract D2 exists. In addition, the development company C3 may file an application for a design registration based on the right to obtain a design registration and acquire a design right. The intellectual property management system according to the present embodiment can also manage information (for example, a design registration number) specifying the design right as information indicating that the design right has been granted.

In addition, there may be a case where the prime contractor C2 requests a design to the subcontractor C1. In this case, the design is delivered from the subcontractor C1 to the prime contractor C2 together with the right to obtain a design registration R1. The intellectual property management system according to the present embodiment manages whether there is a contract D2 proving the transfer of the right to obtain a design registration R1. Furthermore, there may be a case where in the subcontractor C1, a creator P1 (designer) who is actually a natural person may design a design, and the right to obtain a design registration R1 belongs to the creator P1. The intellectual property management system according to the present embodiment manages that the right to obtain a design registration R1 has been transferred from the creator P1 to the subcontractor C1 by a document D1 such as a contract or a work rule. In addition, the intellectual property management system may manages information indicating agreement by the party regarding the transfer of the right, such as an electronic contract, other than a document.

As described above, the intellectual property management system according to the present embodiment can support appropriately and reliably performing the right processing for the design right subject to the license R4 (or sale) from the development company C3 to the customer company C4, by managing transfer of the right to obtain a design registration R1 from the creator P1 to the development company C3, based on the presence or absence of a document or information proving the transfer of the right.

FIG. 2 is a diagram illustrating an overall configuration example of the intellectual property management system according to the present embodiment. The intellectual property management system according to the present embodiment includes a management server 30. The management server 30 is communicably connected to each of a user terminal 10 and a designer terminal 20 via the communication network 40. The communication network 3 is, for example, the Internet, and is constructed by a public telephone network, a mobile telephone network, a wireless communication path, Ethernet (registered trademark), or the like.

The user terminal 10 is a computer used by a user of the intellectual property management system according to the present embodiment (an employer or an employee of the development company C3 in the example of FIG. 1), and is, for example, a smartphone, a tablet computer, a personal computer, or the like. The user can confirm whether or not the right processing for a product is appropriately performed using the user terminal 10.

The designer terminal 20 is a computer used by a creator P1 of the intellectual property (a designer belonging to the subcontractor C1 in the example of FIG. 1), an intermediate party who has received the right transfer from the creator P1 (the prime contractor C2 In the example of FIG. 1), or an employee thereof. The designer terminal 20 is, for example, a smartphone, a tablet computer, a personal computer, or the like. As will be described later, in a case where the management server 30 determines that the right transfer from the creator P1 has not been performed (or there is no document proving the right transfer), a request for requesting the creator P1 or the intermediate party (the prime contractor C2) to whom the right has been transferred to submit a document proving the right transfer (for example, sign on an online contract) is transmitted to the designer terminal 20.

The management server 30 is a computer that confirms that right processing for the intellectual property has been appropriately performed. The management server 30 may be a general-purpose computer such as a workstation or a personal computer, or may be logically realized by cloud computing.

### <Management Server 30>

FIG. 3 is a diagram illustrating a hardware configuration example of a computer that implements the management server 30. Note that the computer illustrated in FIG. 3 can also be used as a hardware configuration example of the user terminal 10 and the designer terminal 20.

The management server 30 includes a CPU 01, a memory 102, a storage device 103, a communication interface 104, an input device 105, and an output device 106. The storage device 103 is, for example, a hard disk drive, a solid state drive, a flash memory, or the like that stores various data and programs. The communication interface 104 is an interface for connection to the communication network 40, and is, for example, an adapter for connection to Ethernet (registered trademark), a modem for connection to a public telephone line network, a wireless communication device for wireless communication, a USB (universal serial bus) connector for serial communication, an RS232C connector, or the like. The input device 105 is, for example, a keyboard, a mouse, a touch panel, a button, a microphone, or the like that inputs data. The output device 106 is, for example, a display, a printer, a speaker, or the like that outputs data.

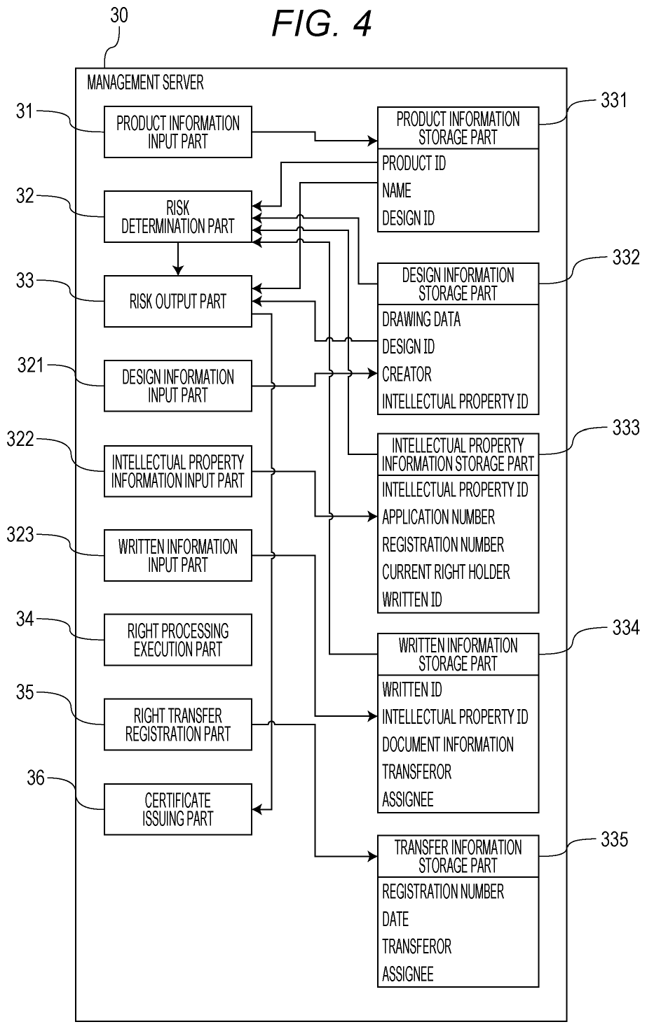

FIG. 4 is a diagram illustrating a software configuration example of the management server 30. As illustrated in the drawing, the management server 30 includes a product information input part 31, a risk determination part 32, a design information input part 321, an intellectual property information input part 322, a written information input part 323, a risk output part 33, a right processing execution part 34, a right transfer registration part 35, a certificate issuing part 36, a product information storage part 331, a design information storage part 332, an intellectual property information storage part 333, a written information storage part 334, and a transfer information storage part 335.

The product information storage part 331 stores information regarding a product (hereinafter, referred to as product information). The product information may include, for example, a product ID for specifying a product, a product name, and a design ID. The design ID is information for specifying design information described later. Although the product information may include a plurality of design IDs, in the present embodiment, in order to simplify the description, it is assumed that the product information includes one design ID.

The product information input part 31 receives an input of product information. In the present embodiment, for example, in a case where the development company C3 sells or licenses a product to the customer company C4, it is assumed that the product information is input. The management server 30 can determine whether or not the right processing for the product is appropriately performed according to the input of the product information. The product information input part 31 registers the received product information in the product information storage part 331.

The risk determination part 32 determines a risk regarding the license or the right transfer. In the present embodiment, the risk determination part 32 can determine a risk that the right processing for a design right is not appropriately performed and a risk that a product is not protected by the design right.

Regarding the risk that the right processing is not appropriately performed, for example, the risk determination part 32 can determine the risk regarding the right processing based on whether or not the transfer of the right from the creator P1 to the right holder of the product (the development company C3 in FIG. 1) continues.

The risk determination part 32 can determine whether the transfer of right is continuous based on design information, intellectual property information, and written information described later. That is, the risk determination part 32 reads the product information corresponding to the product ID indicating the product from the product information storage part 331, reads the design information corresponding to the design ID included in the read product information from the design information storage part 332, and reads the intellectual property information corresponding to the intellectual property ID included in the read design information from the intellectual property information storage part 333. The risk determination part 32 retrieves the written information corresponding to the written ID included in the read intellectual property information from the written information storage part 334, and if the written information is not registered in the written information storage part 334, it can be determined that right processing has not been performed.

In addition, in a case where the transferor of the retrieved written information does not coincide with the creator of the design information, the risk determination part 32 further retrieves the written information. The risk determination part 32 determines the transferor of the read written information as an assignee, and retrieves the written information including the intellectual property ID of the read intellectual property information from the written information storage part 334. Here, if the written information is not registered in the written information storage part 334, the risk determination part can also determine that the right processing has not been performed. Until the transferor of the written information matches the creator of the design information, the risk determination part 32 can determine that the transferor of the written information as an assignee, and sequentially retrieve the written information including the intellectual property ID of the intellectual property information from the written information 334.

In a case where the written information corresponding to the intellectual property ID of the intellectual property information and including the creator of the design information as the transferor is found, the risk determination part 32 can determine that the written information proving a series of transfers from the creator to the current holder of the intellectual property is registered.

The risk determination part 32 can determine based on the design information, the intellectual property information, and the written information, that there is a risk when the transfer of right is continuous, and that there is no risk when the transfer is not continuous.

In addition, for example, the risk determination part 32 can extract text information from document information (such as the content of a contract) included in the written information, analyze the text information, and determine whether there is a term of right transfer. Here, the risk determination part 32 may determine the (lowness of) accuracy of the text analysis processing as a risk. Furthermore, for example, the risk determination part 32 can determine whether text information extracted from the document information includes a description of a special agreement or the like that may hinder the transfer of right, such as a repurchase condition, and determine a value of a risk according to the content of the term.

Furthermore, for example, a risk regarding the content of the contract may be set in the written information, and the risk determination part 32 may calculate the risk regarding the right processing by totaling risks set in the written information. In this case, the user may set a risk in the written information, or the risk determination part 32 may determine a risk according to the content of the document information as described above.

Note that the risk determination part 32 may determine whether or not the right has been transferred without depending on the design information, the intellectual property information, or the written information. For example, the risk determination part 32 can receive, from the user, an input as to whether or not there is a transfer of right between a certain transferor and an assignee (and/or a risk thereof).

The design information storage part 332 stores information regarding a design of a product (design information). The design information may include a design ID for specifying the design information, drawing data representing the design, information indicating a creator of the design, and an intellectual property ID. The intellectual property ID is information for specifying intellectual property information described later. Although the design information may include a plurality of intellectual property IDs, in the present embodiment, in order to simplify the description, it is assumed that the design information includes one intellectual property ID.

The design information input part 321 receives an input of design information. In a case where no design ID is set in the product information, the design information input part 321 can receive an input of new design information. In a case where design information is newly input, the design information input part 321 can write a design ID indicating the design information in the design ID of the corresponding product information. Furthermore, in a case where the design information has already been registered, the design information can be updated.

The intellectual property information storage part 333 stores information regarding an intellectual property right regarding a design of a product (intellectual property information). The intellectual property information may include an application number, a registration number, a current right holder, and a written ID in association with an intellectual property ID that specifies the intellectual property information. The application number and the registration number may be, for example, an application number and a registration number regarding a design registration application in the Patent Office. Before application of a design registration, a reference number in the development company C3 may be set as the application number, and the registration number may be blank. Before registration of the design right, the registration number may be blank. The current right holder is information specifying the right to obtain a design registration or the right holder of the design right. The written ID is information for specifying written information described later. Although the intellectual property information may include a plurality of written IDs, in the present embodiment, it is assumed that the intellectual property information includes one written ID indicating written information regarding the final transfer of right with the current right holder as the assignee.

The intellectual property information input part 322 receives an input of intellectual property information. For example, in a case where the design information does not include an intellectual property ID, the intellectual property information input part can receive an input of new intellectual property information. The intellectual property information input part 322 can register the received intellectual property information in the intellectual property information storage part 333. In a case where a new input of intellectual property information is received, the intellectual property information input part 322 can write an intellectual property ID indicating the intellectual property information in the corresponding design information. For example, the intellectual property information input part 322 can obtain application documents to the Patent Office and create intellectual property information. In this case, the intellectual property information input part 322 can receive designation of the corresponding design information and set the intellectual property ID of the received design information.

The written information storage part 334 stores information regarding a document proving the right transfer regarding the intellectual property of a product (written information). The written information includes the intellectual property ID indicating the intellectual property information regarding the intellectual property right to be transferred, the document information indicating the contents of the document, the transferor, and the assignee in association with the written ID specifying the written information. The written information is information indicating that there is a document proving that the intellectual property right corresponding to the intellectual property ID has been transferred from the transferor to the assignee.

The written information input part 323 receives an input of the written information. For example, in a case where the intellectual property information does not include a written ID, the written information input part 323 can receive an input of new written information. The written information input part 323 can register the received written information in the written information storage part 334. In a case where the written information is newly input, the written information input part 323 can write the written ID indicating the written information in the corresponding intellectual property information. In addition, for example, the written information input part 323 can obtain contract information regarding the transfer of the intellectual property right related to the intellectual property information from a providing server such as an electronic signature service or an electronic contract service, and create the written information based on the obtained contract information.

The risk output part 33 can confirm that the right processing for the intellectual property related to a product has been appropriately performed, and can evaluate the risk related to the right processing. For example, the risk output part 33 can evaluate, as a risk, the number of transfers of the right to acquire the intellectual property right (right to obtain a design registration, and the like) that cannot be proven (or made a prima facie showing) by written information from the primitive right holder (creator) of the intellectual property right to the seller of the product (development company C3). Furthermore, the risk output part 33 may determine a risk, for example, according to the reliability (for example, whether or not a name, a seal, or a signature has been made, and the like) of the document regarding the written information. Furthermore, in a case where there is a difference between the drawing relating to the design of a product and the drawing of the design right, the risk output part 33 can also evaluate the difference as a risk that the design of the product is not protected by the design right. Furthermore, the risk output part 33 can output the evaluated risk. The risk output part 33 may output the risk to an output device 106 such as a display or a printer, or may transmit screen data (for example, can be described by HTML or the like) for displaying the risk to the user terminal 10.

In a case where the transfer of the right relating to the intellectual property relating to a product (right to obtain a design registration, and the like) is not continuous from the creator to the seller of the product (development company C3) (in a case where written information proving a series of transfers is not registered), the right processing execution part 34 can create necessary documents so that the transfers are continuous. The right processing execution part 34 may, for example, create a transfer contract of the right to obtain a design registration as a document proving the transfer of the right to obtain a design registration. In addition, in order to obtain the electronic signature of the contractor for the contract, the right processing execution part 34 can output information requesting the contractor to sign the contract, or print and output the contract, using the electronic signature system. More specifically, for example, in a case where a transfer contract of the right to obtain a design registration from the prime contractor C2 to the development company C3 is not registered, the right processing execution part 34 creates a transfer contract of the right to obtain a design registration from the prime contractor C2 to the development company C3. In addition, the right processing execution part 34 outputs information requesting the transfer contract to be signed to the prime contractor C2 and the development company C3 using, for example, an electronic signature system.

The transfer information storage part 335 stores information regarding the transfer of the intellectual property right (hereinafter referred to as transfer information.). The transfer information includes the transfer date, the transferor, and the assignee in association with information specifying the intellectual property right (in the example of FIG. 4, the registration number of the design right). Note that the transfer information storage part 335 can be managed by a distributed ledger in the blockchain network 50. Furthermore, the transfer information storage part 335 can also be realized as a part of a storage area provided by the memory 102 or the storage device 103.

The right transfer registration part 35 receives an input of transfer information and registers the transfer information in the transfer information storage part 335. The right transfer registration part 35 may receive an input of transfer information from the user, may access a management site of an electronic contract to retrieve a transfer contract regarding the intellectual property right and create the transfer information based on the retrieved transfer contract, or may access a patent database to acquire information regarding a change in right and create the transfer information based on the acquired information.

The certificate issuing part 36 issues a certificate indicating that the right processing has been appropriately performed. The certificate issuing part 36 can issue a certificate in a case where there is no risk evaluated by the risk output part 33 described above. The certificate issuing part 36 can register the issued certificate in the distributed ledger of the blockchain network 50. For example, the certificate issuing part 36 can include, in the certificate, all design information relating to a product, all intellectual property information corresponding to each piece of design information, and all written information corresponding to each piece of intellectual property information. Note that the certificate may include only the design ID, the intellectual property ID, and the written ID. In this case, the design information, the intellectual property information, and the written information can be managed in the distributed ledger of the blockchain network 50.

<Evaluation Processing of Risk for which Right Processing has not been Performed>

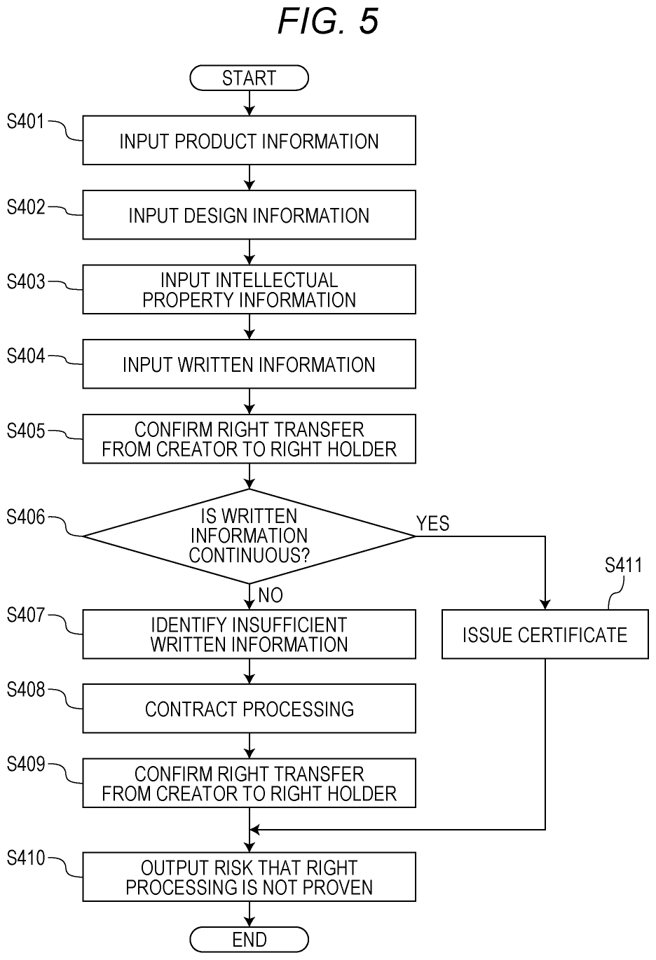

FIG. 5 is a diagram illustrating a flow of processing of evaluating a situation of right processing. The management server 30 receives an input of product information (S401), and receives an input of design information corresponding to the product information (S402). In a case where the corresponding design information is registered, the design information can be read from the design information storage part 332. The management server 30 receives an input of intellectual property information corresponding to the design information (S403). In a case where the corresponding intellectual property information is registered, the intellectual property information can be read from the intellectual property information storage part 333. The management server 30 receives an input of written information corresponding to the intellectual property information (S404). In a case where the corresponding written information is registered, the written information can be read from the written information storage part 334.

The management server 30 confirms whether all written information corresponding to the right transfer continuous from the creator to the right holder of the product (development company C3) exist (S405). For example, the management server 30 retrieves the written information in which the creator of the design information is registered as the transferor, and the intellectual property ID of the design information is set, determines that there is the written information corresponding to the continuous transfer if the assignee is the right holder (development company C3), and if the assignee is other than the right holder (development company C3), further retrieves the written information in which the assignee is set as the transferor, and the intellectual property ID is set. By repeating this, the management server 30 can confirm that all the written information up to the written information in which the assignee is the right holder (development company C3) can be traced.

Here, in a case where the written information is not continuous (S406: NO), the management server 30 may identify insufficient written information (S407) and register the written information (S408). Registration of written information can be performed, for example, by the management server 30 automatically creating a transfer contract by automatically creating a transfer contract and requesting the transferor to sign the transfer contract with an electronic signature or the like. For example, the management server 30 can transmit a message instructing the designer terminal 20 to electronically sign a document in a case where the written information proving the right transfer from the designer P1 belonging to the prime contractor C2 or the subcontractor C1 is not registered. Note that the management server 30 may issue an alert prompting the user to input the written information. When automatically creating a contract document for a transferor such as the designer P1, the management server 30 can inquire of the user whether or not the contract document can be created.

The management server 30 can confirm again whether all written information corresponding to the continuous right transfers from the creator to the right holder of the product (development company C3) exist (S409), and can finally output the risk in which the right processing is not proven (S410). For example, the risk may be set as a rank according to the information that all or part of the written information does not exist or the number of insufficient written information between the transferor and the assignee of the transfer.

On the other hand, in a case where all the written information has been prepared (S406: YES), the management server 30 can issue a certificate to prove that the right processing has been appropriately performed (S411). The management server 30 can create the certificate as electronic data and register the certificate in the ledger of the blockchain network 50. The management server 30 extracts and outputs the certificate registered in the ledger of the blockchain network 50 as needed, so that the user can browse and print the certificate. In step S411, the certificate may be issued as a paper document.

Note that, in a case where the user desires to confirm that the right processing has been performed after registration of the product information, the management server 30 can receive designation of the product, confirm whether or not a certificate corresponding to the designated product is registered in the ledger of the blockchain network 50, output the certificate if the certificate is registered, and perform the processing from step S405 in FIG. 5 if the certificate is not registered. In this case, a certificate may be issued when it is confirmed that the insufficient written information such as the contract has been registered afterwards.

<Evaluation Processing of Risk that Product is not Protected by Design Right>

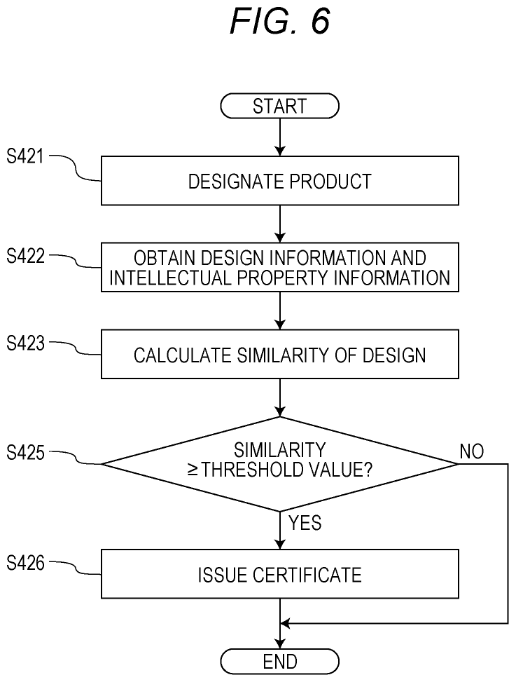

After registration of the product information, design change or the like may be performed. In the intellectual property management system of the present embodiment, the user can confirm the risk of whether or not the current product is protected by the design right. FIG. 6 is a diagram illustrating an example of processing of evaluating a risk in which a product is not protected by a design right.

The management server 30 receives designation of a product (S421), specifies product information corresponding to the designated product, reads design information corresponding to a design ID of the specified product information from the design information storage part 332, and reads intellectual property information corresponding to an intellectual property ID of the specified design information from the intellectual property information storage part 333 (S422). The management server 30 obtains the similarity between the design of the product and the design for the design right (S423). For example, the management server 30 can calculate the similarity between the drawing data included in the design information and the drawing of the design publication corresponding to the registration number included in the intellectual property information using, for example, a known method of image analysis.

Here, in a case where the similarity is equal to or greater than the predetermined threshold value (namely, the product is protected by the design right) (S425: YES), the management server 30 determines that the product is protected by the design right. In addition, a certificate proving the above is issued (S426). Here, the management server 30 can also create the certificate as electronic data and register the electronic data in the ledger of the blockchain network 50. The management server 30 extracts and outputs the certificate, which is registered in the ledger of the blockchain network 50 and proves that the product is protected by the design right, as needed, so that the user can browse and print the certificate. In step S426, in a case where the issued certificate has been registered in the ledger of the blockchain network 50, the management server 30 may acquire the certificate from the ledger and output the certificate without newly issuing the certificate. Note that, also in step S426, the certificate can be issued as a paper document.

Note that the certificate may be issued to prove that the right processing has been appropriately performed and the product is protected by the design right in a case where all the written information has been prepared and the similarity is equal to or greater than a predetermined threshold value.

As described above, according to the intellectual property management system of the present embodiment, it is possible to confirm that the right processing of the intellectual property related to the product is appropriately performed. For example, it can be confirmed that the right to obtain design registration from the creator to the right holder of the design right has been transferred in writing with respect to the design right relating to the design of the product. Therefore, in selling or licensing the product, there is no concern about the right processing, and the risk regarding the intellectual property can be reduced.

Furthermore, according to the intellectual property management system of the present embodiment, it is possible to output the risk regarding the right processing for the intellectual property relating to the product.

In addition, according to the intellectual property management system of the present embodiment, in a case where a document proving the transfer of the right (right to obtain a design registration, or the like) necessary for the acquisition of the intellectual property from the creator to the right holder of the intellectual property is not continuous, it is possible to automatically create a document so that the transfer of the right is continuous.

Although the present embodiment has been described above, the above embodiment is for facilitating understanding of the present invention, and is not intended to limit and interpret the present invention. The present invention can be modified and improved without departing from the gist thereof, and the present invention includes equivalents thereof.

For example, in the present embodiment, the management server 30 is one computer, but the present invention is not limited thereto, and the functions of the management server 30 may be distributed and deployed by a plurality of computers.

In the present embodiment, the product information, the design information, the intellectual property information, and the written information are associated with each other by the design ID, the intellectual property ID, and the written ID. However, the present invention is not limited thereto, and the product information, the design information, the intellectual property information, and the written information may not be associated with each other. In this case, for example, the product information and the design information can be associated by determining the similarity between the drawing of the product and the drawing relating to the design by image processing and determining whether or not the similarity is equal to or greater than a predetermined similarity. In addition, for example, the design information and the intellectual property information can be associated with each other based on similarity between a drawing relating to a design and a drawing relating to an intellectual property right (such as a drawing of a design publication or a patent publication). The association between the intellectual property information and the written information can be performed by determining whether or not the document information includes information identifying the intellectual property right (For example, a registration number, a reference number, and the like).

<Evaluation Processing of Risk that Product is not Protected by Design Right>

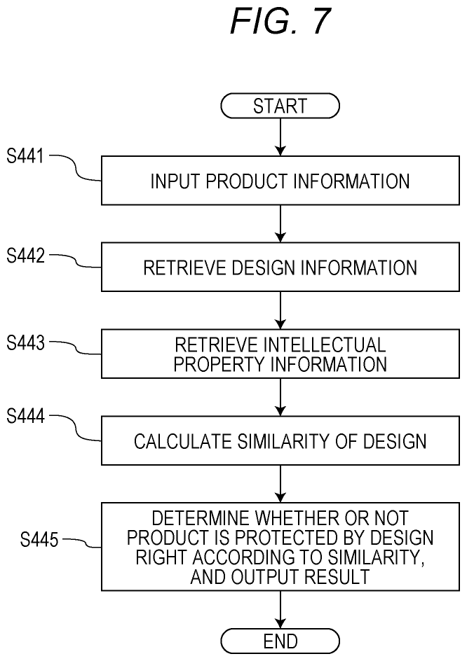

FIG. 7 is a diagram illustrating an example of processing of evaluating the risk that the product is not protected by the design right in a case where the product information, the design information, the intellectual property information, and the written information are not associated.

The management server 30 receives an input of the product information (S441). It is assumed that the product information includes a drawing (or an image such as a photograph) of a product. The management server 30 retrieves design information having a drawing similar to the drawing of the product (S442), and retrieves intellectual property information having a drawing similar to the drawing of the design information (S443). Here, similarly to step S423 of FIG. 6 described above, the management server 30 can obtain the similarity between the design of the product and the design for the design right (S444), determine whether or not the product is protected by the design right according to the similarity (according to the low similarity), and output the result (S445). In addition, a result of the output may be issued as a certificate.

### REFERENCE SIGNS LIST

10 USER TERMINAL
20 DESIGNER TERMINAL
30 MANAGEMENT SERVER
31 PRODUCT INFORMATION INPUT PART
32 RISK DETERMINATION PART
33 RISK OUTPUT PART
34 RIGHT PROCESSING EXECUTION PART
35 RIGHT TRANSFER REGISTRATION PART
36 CERTIFICATE ISSUING PART
321 DESIGN INFORMATION INPUT PART
322 INTELLECTUAL PROPERTY INFORMATION INPUT PART
323 WRITTEN INFORMATION INPUT PART
331 PRODUCT INFORMATION STORAGE PART
332 DESIGN INFORMATION STORAGE PART
333 INTELLECTUAL PROPERTY INFORMATION STORAGE PART
334 WRITTEN INFORMATION STORAGE PART
335 TRANSFER INFORMATION STORAGE PART
FIG. 1
C1 SUBCONTRACTOR
C2 PRIME CONTRACTOR
C3 DEVELOPMENT COMPANY
C4 CUSTOMER COMPANY
R1 RIGHT TO OBTAIN DESIGN REGISTRATION
R4 LICENSE
P1 DESIGNER
D1 CONTRACT/WORK RULE, OR THE LIKE
D2 CONTRACT
D3 CONTRACT
D4 CONTRACT
DESIGN RIGHT
PATENT OFFICE
FIG. 2
10 USER TERMINAL
20 DESIGNER TERMINAL
30 MANAGEMENT SERVER
50 BLOCKCHAIN NETWORK
FIG. 3
COMPUTER
102 MEMORY
103 STORAGE DEVICE
104 COMMUNICATION INTERFACE
105 INPUT DEVICE
106 OUTPUT DEVICE
FIG. 4
30 MANAGEMENT SERVER
31 PRODUCT INFORMATION INPUT PART
32 RISK DETERMINATION PART
33 RISK OUTPUT PART
321 DESIGN INFORMATION INPUT PART
322 INTELLECTUAL PROPERTY INFORMATION INPUT PART
323 WRITTEN INFORMATION INPUT PART
34 RIGHT PROCESSING EXECUTION PART
35 RIGHT TRANSFER REGISTRATION PART
36 CERTIFICATE ISSUING PART
331 PRODUCT INFORMATION STORAGE PART
PRODUCT ID
NAME
DESIGN ID
332 DESIGN INFORMATION STORAGE PART
DRAWING DATA
DESIGN ID
CREATOR
INTELLECTUAL PROPERTY ID
333 INTELLECTUAL PROPERTY INFORMATION STORAGE PART
INTELLECTUAL PROPERTY ID
APPLICATION NUMBER
REGISTRATION NUMBER
CURRENT RIGHT HOLDER
WRITTEN ID
334 WRITTEN INFORMATION STORAGE PART
WRITTEN ID
INTELLECTUAL PROPERTY ID
DOCUMENT INFORMATION
TRANSFEROR
ASSIGNEE
335 TRANSFER INFORMATION STORAGE PART
REGISTRATION NUMBER
DATE
TRANSFEROR
ASSIGNEE
FIG. 5
START
S401 INPUT PRODUCT INFORMATION
S402 INPUT DESIGN INFORMATION
S403 INPUT INTELLECTUAL PROPERTY INFORMATION
S404 INPUT WRITTEN INFORMATION
S405 CONFIRM RIGHT TRANSFER FROM CREATOR TO RIGHT HOLDER
S406 IS WRITTEN INFORMATION CONTINUOUS?
S407 IDENTIFY INSUFFICIENT WRITTEN INFORMATION
S408 CONTRACT PROCESSING
S409 CONFIRM RIGHT TRANSFER FROM CREATOR TO RIGHT HOLDER
S410 OUTPUT RISK THAT RIGHT PROCESSING IS NOT PROVEN
S411 ISSUE CERTIFICATE
END
FIG. 6
START
S421 DESIGNATE PRODUCT
S422 OBTAIN DESIGN INFORMATION AND INTELLECTUAL PROPERTY
INFORMATION
S423 CALCULATE SIMILARITY OF DESIGN
S425 SIMILARITY ≥THRESHOLD VALUE?
S426 ISSUE CERTIFICATE
END
FIG. 7
START
S441 INPUT PRODUCT INFORMATION
S442 RETRIEVE DESIGN INFORMATION
S443 RETRIEVE INTELLECTUAL PROPERTY INFORMATION
S444 CALCULATE SIMILARITY OF DESIGN
S445 DETERMINE WHETHER OR NOT PRODUCT IS PROTECTED BY
DESIGN RIGHT ACCORDING TO SIMILARITY, AND OUTPUT RESULT
END

1. A management server for an intellectual property right, comprising:
a risk determination part configured to determine a risk regarding right processing for the intellectual property right according to whether or not the right processing for the intellectual property right has been performed; and
a risk output part configured to output information regarding the risk.

2. The management server for the intellectual property right according to claim 1,
wherein the right processing is that the intellectual property right has been transferred from a creator of the intellectual property right to a current holder of the intellectual property right,
the management server further comprising a written information input part configured to receive an input of written information proving transfer of the intellectual property right.

3. The management server for the intellectual property right according to claim 2, further comprising
a right processing execution part configured to, in a case where the written information proving transfer of the right does not exist, create a document proving transfer of the right.

4. The management server for the intellectual property right according to claim 1, further comprising
a transfer information storage part configured to store information regarding transfer of the intellectual property right.

5. The management server for the intellectual property right according to claim 1, further comprising
a certificate issuing part configured to issue a certificate indicating that the right processing has been performed in a case where it is determined that the right processing for the intellectual property right has been performed.

6. The management server for the intellectual property right according to claim 5,
wherein the certificate issuing part registers the certificate in a distributed ledger of a blockchain network.

7. The management server for the intellectual property right according to claim 1,
wherein the intellectual property right is a design right, and
the risk determination part determines a state of protection of a product by the design right according to a similarity between a design for the product and a design for the design right.

8. A program for causing a management server for an intellectual property right to function as:
a risk determination means configured to determine a risk regarding right processing of the intellectual property right according to whether or not the right processing for the intellectual property right has been performed; and
a risk output means configured to output information regarding the risk.

9. A management method for an intellectual property right, comprising:
a risk determination step of determining a risk regarding right processing of the intellectual property right according to whether or not the right processing for the intellectual property right has been performed; and
a risk output step of outputting information regarding the risk.
